(19) United States
(12) Patent Application Publication
(10) Pub. No.: US 2021/0082100 A1
(43) Pub. Date: Mar. 18, 2021

(54) IMAGE INSPECTION APPARATUS, IMAGE INSPECTION METHOD, AND IMAGE INSPECTION PROGRAM

(71) Applicant: Konica Minolta Inc., Tokyo (JP)

(72) Inventor: Yasumasa TSUKAMOTO, Tokyo (JP)

(21) Appl. No.: 16/944,939

(22) Filed: Jul. 31, 2020

(30) Foreign Application Priority Data
Sep. 12, 2019 (JP) 2019-165822

(51) Int. Cl. G06T 7/00; H04N 1/00

(52) U.S. Cl. CPC G06T 7/001; H04N 2201/0081; H04N 1/00748

(57) ABSTRACT

An image inspection apparatus that performs inspection on an image obtained by reading a sheet on which a document image is printed, includes: a hardware processor that controls the inspection; an inspection level setter that sets an inspection level of the inspection; a first image inspector that performs the inspection with an image obtained by reading a sheet printed in a proof mode as a reference image; and a second image inspector that performs the inspection with the document image as a reference image, wherein the hardware processor causes the second image inspector to execute the inspection when the inspection level is set relatively low, and causes the first image inspector to execute the inspection when the inspection level is set relatively high.

The entire disclosure of Japanese patent Application No. 2019-165822, filed on Sep. 12, 2019, is incorporated herein by reference in its entirety.

### BACKGROUND

### Technological Field

The present invention relates to an image inspection apparatus, an image inspection method, and an image inspection program, and particularly to an image inspection apparatus that inspects an image obtained by reading a document image printed on a sheet, an image inspection method using the image inspection apparatus, and an image inspection program that operates in the image inspection apparatus.

### Description of the Related art

In printing that requires high quality such as production printing, quality inspection on printed matter is required. For example, an inspection apparatus is known that performs difference inspection by creating an image obtained by reading a sheet printed in a proof mode (test printing) in advance as a reference image, and by comparing an image obtained by reading a printed sheet (inspection image) with the reference image in an inspection mode.

When the image obtained by reading the sheet printed in the proof mode is used as the reference image, an inspector visually confirms whether there is no abnormality such as a stain in the printed matter in the proof mode, and if there is no abnormality, the image is determined as the reference image; however, this step must be performed for all pages of the print job, so that it takes time and labor. To solve this problem, a printed matter inspection apparatus is known that inspects quality of printed matter by comparing a reference image generated from a document image that is a generation source of the printed matter with an inspection image obtained by reading a printed sheet.

For example, in JP 2015-53561 A, a printed matter inspection apparatus is disclosed including: a reading unit that reads printed matter and generates an inspection image; an acquisition unit that acquires an original image that is a generation source of the printed matter; a multi-value conversion unit that makes a source image multivalued; a first smoothing unit that performs first smoothing on the multivalued original image; a detection unit that performs edge detection using an edge threshold based on the number of printed lines of the printed matter, on the original image subjected to the first smoothing; a second smoothing unit that performs second smoothing on a non-edge region of the multivalued original image corresponding to a region not detected as an edge in the edge detection; an image processor that performs image processing on the original image subjected to the second smoothing to generate a master image; and an inspector that inspects quality of the printed matter by comparing the inspection image with the master image.

When the inspection is performed with the document image that is the generation source of the printed matter as the reference image, the document image and the image obtained by reading the printed sheet have different image formats and colors, and therefore cannot be directly compared with each other. Thus, to reduce a difference between the images, various corrections such as density correction and tone correction, resolution conversion, color conversion, and the like are performed on the document image. However, even if such image processing is performed, there has been a problem that the difference between the images is large and the inspection accuracy is degraded as compared with a case where the image obtained by reading the sheet printed in the proof mode is used as the reference image.

### SUMMARY

The present invention has been made in view of the above problems, and its main purpose is to provide an image inspection apparatus, an image inspection method, and an image inspection program capable of performing image inspection in consideration of reducing the time and labor for the inspector to visually confirm the read image, and maintaining sufficient inspection accuracy.

To achieve the abovementioned object, according to an aspect of the present invention, there is provided an image inspection apparatus that performs inspection on an image obtained by reading a sheet on which a document image is printed, and the image inspection apparatus reflecting one aspect of the present invention comprises: a hardware processor that controls the inspection; an inspection level setter that sets an inspection level of the inspection; a first image inspector that performs the inspection with an image obtained by reading a sheet printed in a proof mode as a reference image; and a second image inspector that performs the inspection with the document image as a reference image, wherein the hardware processor causes the second image inspector to execute the inspection when the inspection level is set relatively low, and causes the first image inspector to execute the inspection when the inspection level is set relatively high.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram illustrating a configuration of an image inspection system according to a first embodiment of the present invention;

FIG. 2 is a block diagram illustrating the configuration of the image inspection system according to the first embodiment of the present invention;

FIG. 3 is a block diagram illustrating a main configuration of the image inspection system related to an image inspection method of the first embodiment of the present invention;

FIG. 4 is a schematic diagram illustrating schematic operation of the image inspection system according to the first embodiment of the present invention;

FIG. 5 is an example of a screen (inspection level setting screen) displayed on the image inspection system according to the first embodiment of the present invention;

FIG. 6 is a schematic diagram explaining an image inspection method according to the first embodiment of the present invention;

FIG. 7 is a flowchart illustrating operation of the image inspection system according to the first embodiment of the present invention;

FIG. 8 is a flowchart illustrating operation (image inspection 1) of the image inspection system according to the first embodiment of the present invention;

FIG. 9 is a flowchart illustrating operation of an image inspection system according to a second embodiment of the present invention;

FIG. 10 is a flowchart illustrating operation (image inspection 2) of the image inspection system according to the second embodiment of the present invention;

FIG. 11 is a flowchart illustrating operation (image inspection 2) of the image inspection system according to the second embodiment of the present invention;

FIG. 12 is a flowchart illustrating operation (image inspection 3) of the image inspection system according to the second embodiment of the present invention;

FIGS. 13A and 13B are schematic diagrams explaining the image inspection according to the second embodiment of the present invention;

FIGS. 14A to 14C are schematic diagrams explaining the image inspection according to the second embodiment of the present invention; and

FIG. 15 is an example of a screen (inspection result screen) displayed on the image inspection system according to the second embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

As described in the related art, in printing that requires high quality such as production printing, quality inspection on printed matter is required, and inspection has been performed that creates an image obtained by reading a sheet printed in the proof mode (test printing) in advance as a reference image, and compares an image obtained by reading a printed sheet (inspection image) with the reference image in the inspection mode (actual printing after test printing).

As described above, when the image obtained by reading the sheet printed in the proof mode is used as the reference image, an inspector needs to visually confirm whether there is no abnormality such as a stain on the printed matter (all pages of the print job) in the proof mode, and it takes time and labor. Thus, a method has been devised of inspecting quality of the printed matter by comparing a reference image generated from a document image that is a generation source of the printed matter with an inspection image obtained by reading a printed sheet.

However, when the inspection is performed with the document image that is the generation source of the printed matter as the reference image, the document image and the image obtained by reading the printed sheet have different image formats and colors, and cannot be directly compared with each other. Thus, various corrections such as density correction and tone correction, resolution conversion, color conversion, and the like are performed on the document image; however, there has been a problem that the difference between the images is large and the inspection accuracy is degraded as compared with a case where the image obtained by reading the sheet printed in the proof mode is used as the reference image.

Thus, in one embodiment of the present invention, an image inspection apparatus that performs inspection on an image obtained by reading a sheet on which a document image is printed is provided with: a controller that controls the inspection; an inspection level setter that sets an inspection level of the inspection; a first image inspector that performs the inspection with an image obtained by reading a sheet printed in a proof mode as a reference image; and a second image inspector that performs the inspection with the document image that is the generation source of printed matter as a reference image, in which the controller causes the second image inspector to execute the inspection when the inspection level is set relatively low, and causes the first image inspector to execute the inspection when the inspection level is set relatively high.

As a result, when the inspection level is set relatively low, it is not necessary for the inspector to visually confirm whether there is no abnormality such as a stain in the printed matter in the proof mode, so that time and labor can be reduced, and when the inspection level is set relatively high, sufficient inspection accuracy can be maintained

### First Embodiment

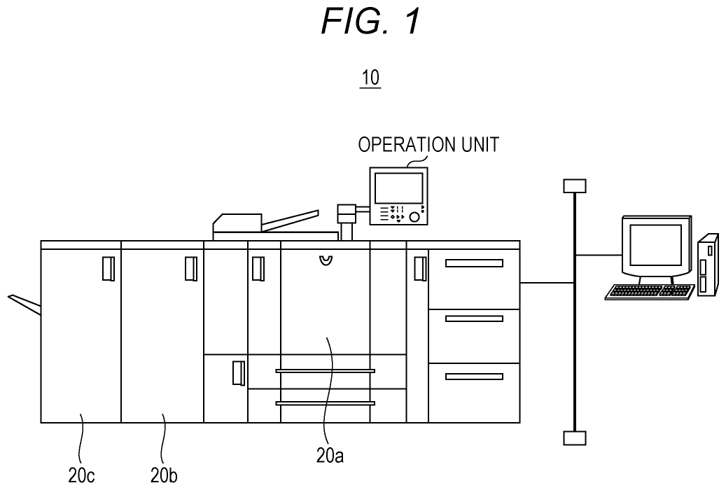

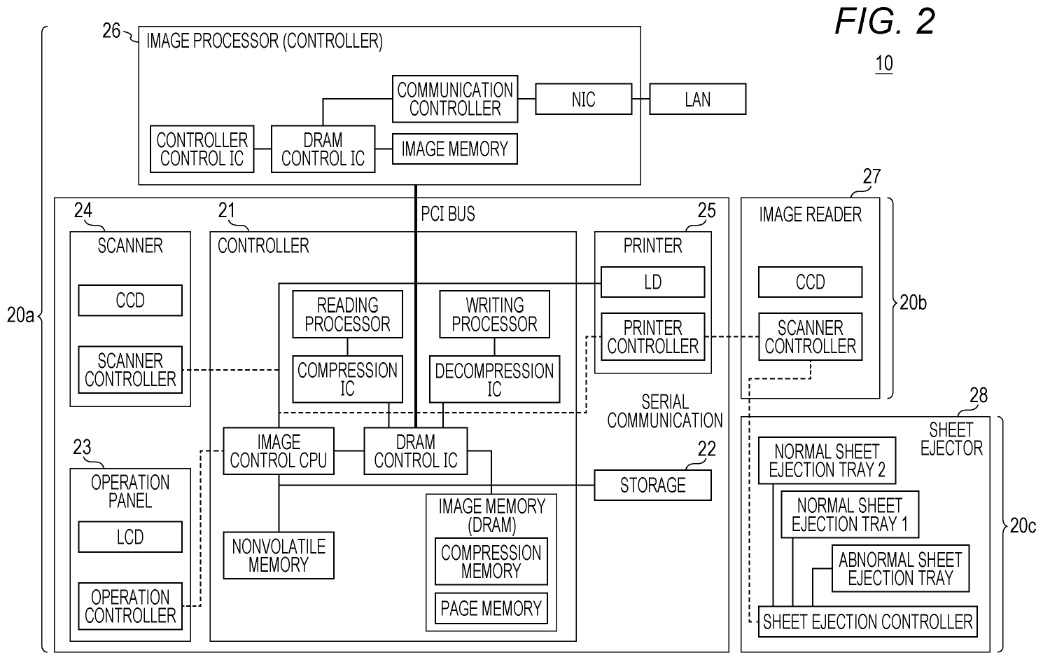

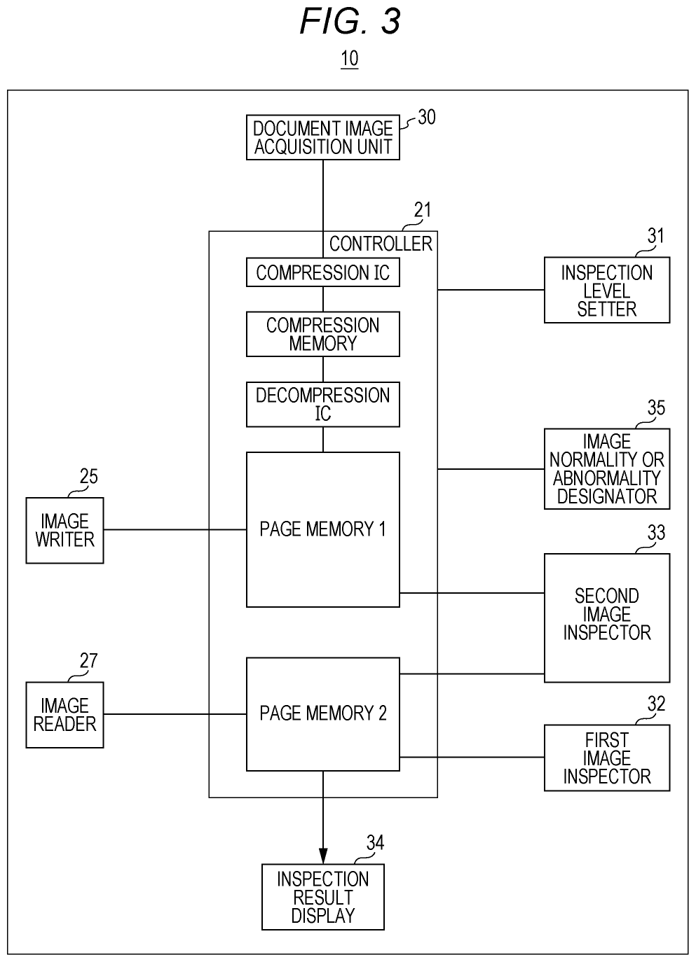

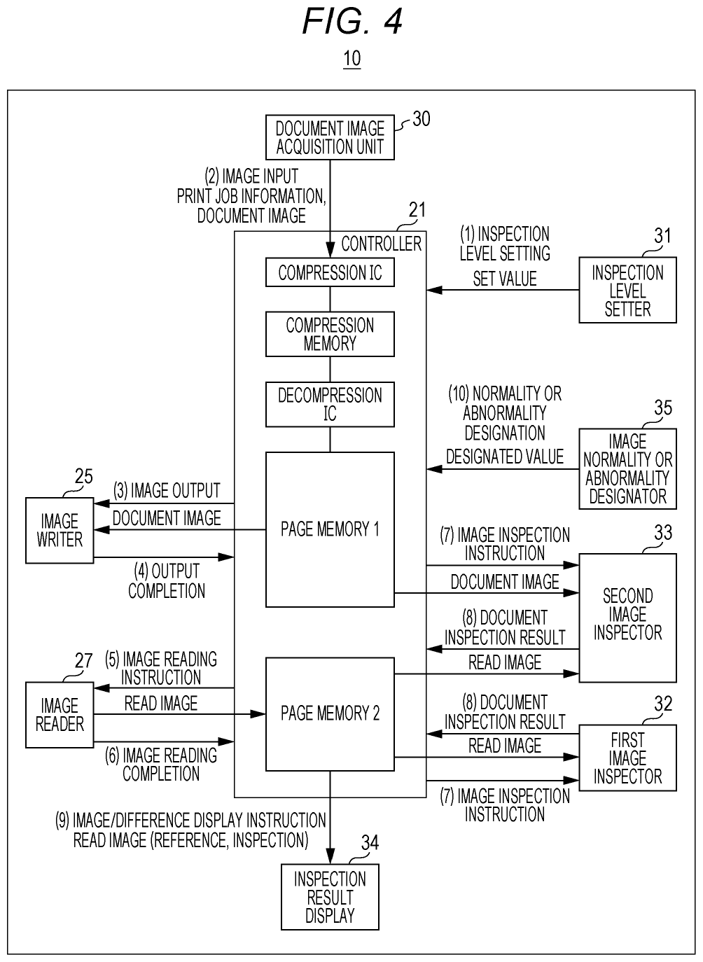

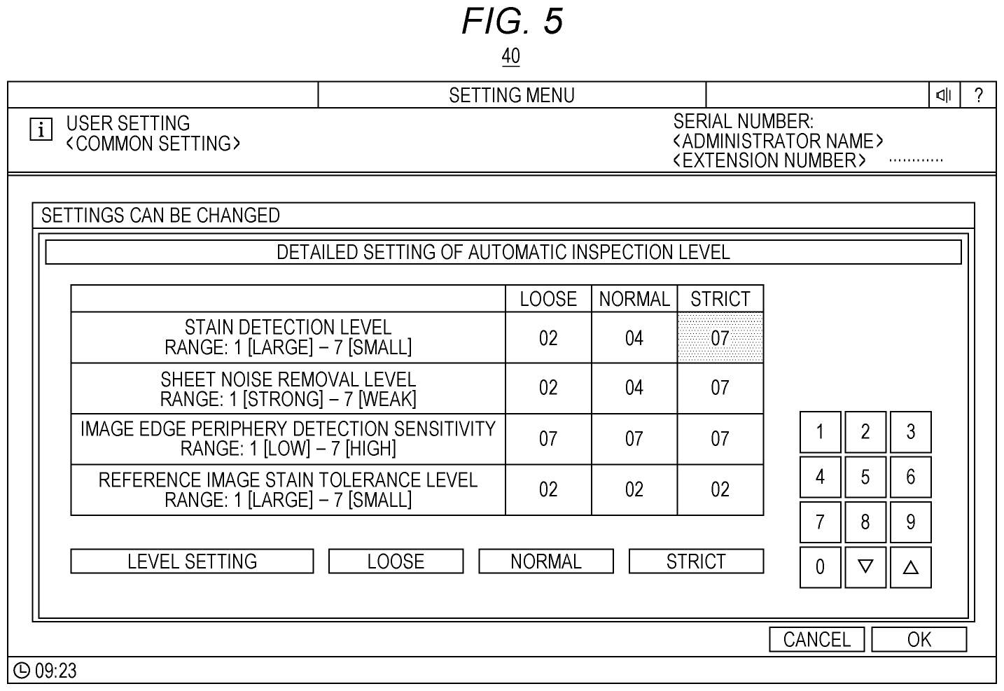

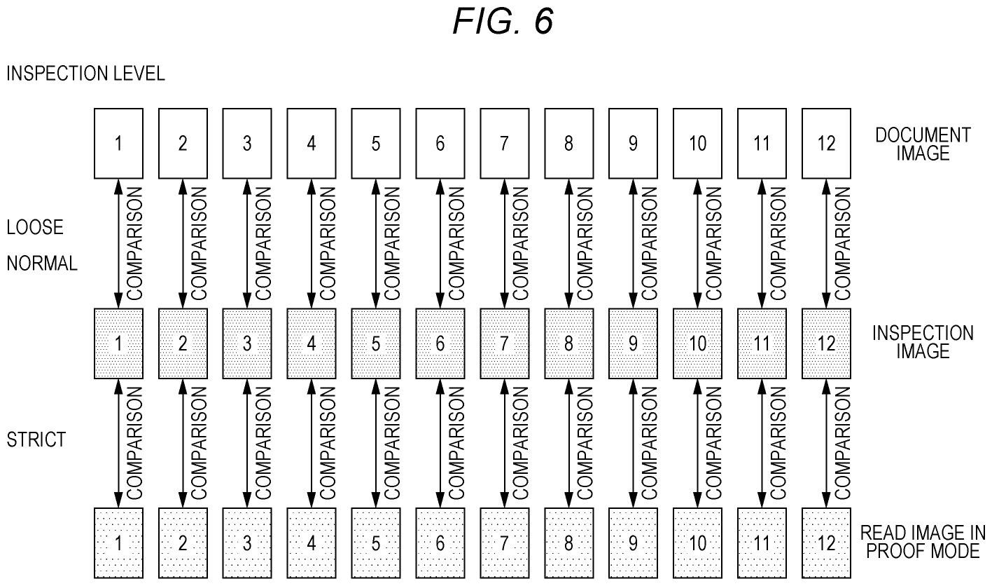

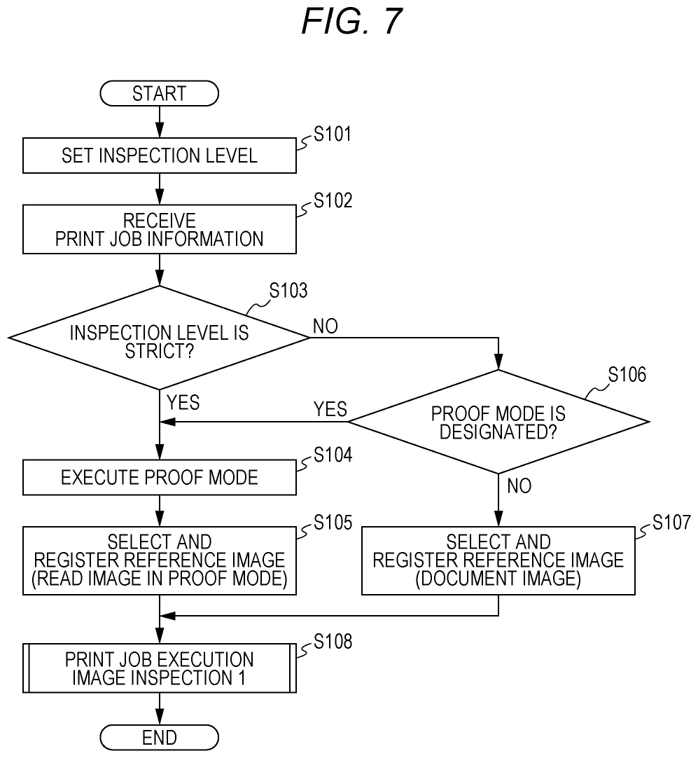

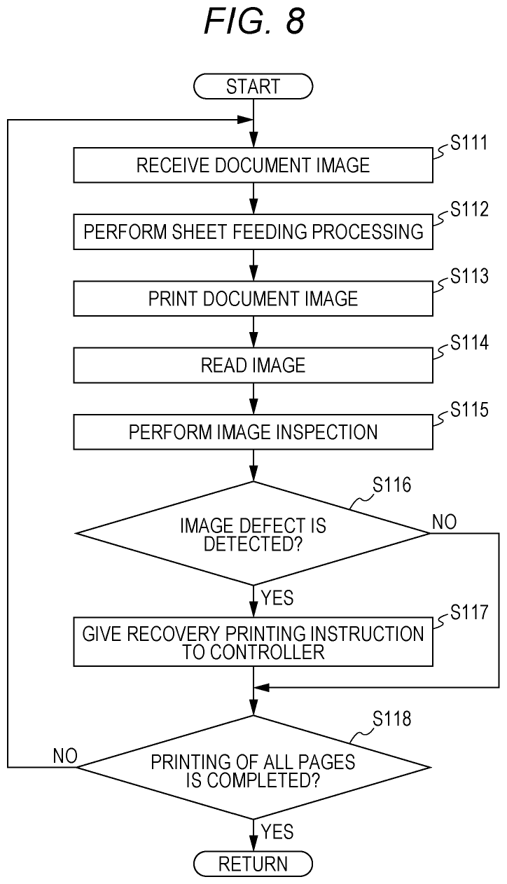

To give more detailed description of the embodiment of the present invention described above, description will be given of an image inspection apparatus, an image inspection method, and an image inspection program according to a first embodiment of the present invention with reference to FIGS. 1 to 8. FIG. 1 is a schematic diagram illustrating a configuration of an image inspection system of the present embodiment, and FIG. 2 is a block diagram illustrating the configuration of the image inspection system. Furthermore, FIG. 3 is a block diagram illustrating a main configuration of the image inspection system related to the image inspection method of the present embodiment, and FIG. 4 is a schematic diagram illustrating schematic operation of the image inspection system of the present embodiment. Furthermore, FIG. 5 is an example of a screen (inspection level setting screen) displayed on the image inspection system of the present embodiment, FIG. 6 is a schematic diagram explaining the image inspection method according to the present embodiment, and FIGS. 7 and 8 are flowcharts illustrating operation of the image inspection system of the present embodiment.

Note that, in the following description, an operation mode in which printed matter to be a product is created is referred to as an inspection mode, and an operation mode in which test printing of the printed matter is performed before the inspection mode is referred to as a proof mode. Furthermore, an image obtained by reading a sheet printed in the inspection mode is referred to as an inspection image, and an image as a reference during inspection of the inspection image is referred to as a reference image.

As illustrated in FIG. 1, an image inspection system 10 of the present embodiment includes an image forming apparatus 20a that prints a document image on a sheet, an image inspection apparatus 20b that reads and inspects the sheet after printing, and a sheet ejection apparatus 20c that sorts and ejects the sheet after printing.

FIG. 2 is a block diagram illustrating a configuration of the image inspection system 10 of the present embodiment. As illustrated in FIG. 2, the image forming apparatus 20a includes a controller 21, a storage 22, an operation panel 23, a scanner (image reader) 24, a printer (image writer) 25, an image processor 26, and the like. Furthermore, the image inspection apparatus 20b includes an image reader 27 and the like. Furthermore, the sheet ejection apparatus 20c includes a sheet ejector 28 and the like.

The controller 21 generally includes a Central Processing Unit (CPU) and memories such as Read Only Memory (ROM) and Random Access Memory (RAM), and these are connected to each other via a bus. The CPU performs overall control of the image inspection system 10 by reading a program from the ROM or the storage 22, deploying the program in the RAM, and executing the program. In the present embodiment, the controller 21 includes an image control CPU, a nonvolatile memory, a DRAM control Integrated Circuit (IC), an image memory (DRAM), a decompression IC, a writing processor, a compression IC, a reading processor, and the like, and the image memory includes a compression memory and a page memory.

The storage 22 includes a Hard Disk Drive (HDD), a Solid State Drive (SSD), or the like, and stores various programs and various types of information for the CPU to control each part.

The operation panel 23 includes a display such as a Liquid Crystal Display (LCD) and an operation controller that controls an operation unit such as a touch sensor including a lattice-shaped transparent electrode, and displays various screens (in particular, an inspection level setting screen, an inspection result screen, and the like described later), and also enables various operations on the screens (for example, inspection level setting operation on the inspection level setting screen, image normality or abnormality designation operation on the inspection result screen, and the like). Note that, the inspection level setting screen and the inspection result screen may be displayed on the operation panel 23 mounted on the image inspection system 10, or may be displayed on a display of an external apparatus (for example, a client apparatus) connected on a network.

The scanner (image reader) 24 is a part that optically reads image data from a document placed on a document table, and includes a Charge Coupled Device (CCD) that converts light reflected by the document into an electrical signal, and a scanner controller that operates the CCD and processes the electrical signal output from the CCD, and the like.

The printer (image writer) 25 is an engine that executes print processing on the basis of the image data, and includes, for example, a Laser Diode (LD) that irradiates a charged photoreceptor drum with laser light corresponding to the image to form an electrostatic latent image, a printer controller that performs various controls for visualizing the electrostatic latent image and forming an image on a sheet, and the like.

The image processor 26 is connected to the DRAM control IC of the controller 21 via a Peripheral Components Interconnect (PCI) bus, and performs image processing and functions as a controller that controls the scanner 24 and the printer 25. In the present embodiment, the image processor 26 includes a controller control IC, a DRAM control IC, an image memory, a communication controller, a Network Interface Card (NIC), and the like, and establishes a connection with another apparatus connected by a communication network such as a Local Area Network (LAN), receives a print job from an external apparatus (for example, a client apparatus, or the like), and transmits the image data read by the scanner 24 to the external apparatus by electronic mail.

The image reader 27 is an in-line scanner or the like that optically reads image data from the sheet printed by the image forming apparatus 20a, and includes a CCD that converts light reflected by the sheet into an electrical signal, and a scanner controller that operates the CCD and processes the electrical signal output from the CCD, and the like. Note that, when the image forming apparatus 20a includes an in-line scanner that scans the printing sheet after image formation, an image read by the in-line scanner may be a target of image inspection, and in that case, the image reader 27 can be omitted.

The sheet ejector 28 includes a plurality of sheet ejection trays (here, a normal sheet ejection tray 1, a normal sheet ejection tray 2, and an abnormal sheet ejection tray), and a sheet ejection controller that controls which ejection tray is used for ejection, and the sheet ejection controller ejects a sheet having a normal image to the normal sheet ejection tray 1 or the normal sheet ejection tray 2, and ejects a sheet having an abnormal image to the abnormal sheet ejection tray in accordance with an inspection result of the image inspection apparatus 20b.

FIG. 3 is a block diagram illustrating a main configuration related to the image inspection method in the image inspection system 10 of the present embodiment. The image inspection system 10 of the present embodiment includes the controller 21, the image writer 25, the image reader 27, a document image acquisition unit 30, an inspection level setter 31, a first image inspector 32, a second image inspector 33, an inspection result display 34, an image normality or abnormality designator 35, and the like.

The controller 21 includes the compression IC, the compression memory, the decompression IC, a page memory 1 and a page memory 2, and controls image input, image output, image inspection, and image display.

The image writer 25 is an engine that executes print processing on the basis of image data, as described above.

The image reader 27 is an in-line scanner or the like that optically reads image data from a sheet printed by the image forming apparatus 20a, as described above.

The document image acquisition unit 30 acquires print job information including a document image from the image processor (controller) 26 or the like.

The inspection level setter 31 sets the inspection level of the image inspection in accordance with an input from the operation panel 23 on the inspection level setting screen described later. In the present embodiment, the inspection level is set to any of “strict”, “normal”, or “loose”.

With an image obtained by reading a sheet printed in the proof mode as a reference image, the first image inspector 32 performs image inspection of an inspection image by comparing the reference image with the inspection image. The first image inspector 32 executes the image inspection in accordance with an instruction of the controller 21 when the inspection level is set relatively high (for example, set to “strict”) by the inspection level setter 31.

With a document image that is a generation source of printed matter as a reference image, the second image inspector 33 performs image inspection of an inspection image by comparing the reference image with the inspection image. The second image inspector 33 performs the image inspection in accordance with an instruction of the controller 21 when the inspection level is set relatively low (for example, set to “normal” or “loose”) by the inspection level setter 31.

The inspection result display 34 displays the reference image obtained by reading the sheet printed in the proof mode (or the reference image and the inspection image) on the inspection result screen described later. Furthermore, the inspection result display 34 clearly indicates a difference portion between the reference image and the inspection image on the inspection result screen. The inspection result display 34 can be omitted in the first embodiment.

The image normality or abnormality designator 35 accepts designation of whether the reference image obtained by reading the sheet printed in the proof mode and the inspection image are normal or abnormal on the inspection result screen described later. The image normality or abnormality designator 35 can be omitted in the first embodiment.

Note that, the document image acquisition unit 30, the inspection level setter 31, the first image inspector 32, the second image inspector 33, the inspection result display 34, and the image normality or abnormality designator 35 may be configured as hardware, or may be configured as an inspection control program that causes the controller 21 to function as the document image acquisition unit 30, the inspection level setter 31, the first image inspector 32, the second image inspector 33, the inspection result display 34, and the image normality or abnormality designator 35 (in particular, the inspection level setter 31, the first image inspector 32, and the second image inspector 33), and the inspection control program may be executed by the CPU of the controller 21.

Hereinafter, description will be given of an image inspection method using the image inspection system 10 having the above configuration with reference to the schematic diagram of FIG. 4.

(1) The inspection level setter 31 sets the inspection level of the image inspection in accordance with the input from the operation panel 23, and notifies the controller 21 of a set value.

(2) The document image acquisition unit 30 acquires print job information including a document image from the image processor (controller) 26 and notifies the controller 21 of the print job information. When a print job is started, the controller 21 compresses the document image input from the document image acquisition unit 30 with the compression IC and stores the compressed document image in the compression memory. Furthermore, the controller 21 decompresses the compressed image stored in the compression memory with the decompression IC and stores the decompressed image in the page memory 1.

(3) The controller 21 transmits the document image stored in the page memory 1 to the image writer 25, and gives an instruction to output the document image.

(4) The image writer 25 writes the document image on a printing sheet, and when ejection of the printing sheet is completed, notifies the controller 21 of output completion of the printing sheet.

(5) The controller 21 instructs the image reader 27 to read an image.

(6) The image reader 27 reads the sheet after printing, transmits a read image to the controller 21, and notifies the controller 21 of reading completion of the image. The controller 21 stores the read image in the page memory 2.

(7) The controller 21 instructs the first image inspector 32 to perform the image inspection when the inspection level is set to “strict” in setting of the inspection level of (1), and instructs the second image inspector 33 to perform the image inspection when the inspection level is set to “loose” or “normal”.

(8) The first image inspector 32 performs the image inspection by comparing the reference image (the image obtained by reading the sheet printed in the proof mode) stored in the page memory 2 with the inspection image stored in the page memory 2, and the second image inspector 33 performs the image inspection by comparing the reference image (document image) stored in the page memory 1 with the inspection image stored in the page memory 2, and notifies the controller 21 of an image inspection result.

(9) The controller 21 instructs the inspection result display 34 to display the reference image (the image obtained by reading the sheet printed in the proof mode) and the inspection image, and to display a difference portion between the reference image and the inspection image. The inspection result display 34 displays the reference image and the inspection image on the operation panel 23, and clearly indicates the difference portion.

(10) The image normality or abnormality designator 35 accepts designation of whether the reference image (the image obtained by reading the sheet printed in the proof mode) and the inspection image are normal or abnormal, and notifies the controller 21 of a designated value. The controller 21 controls processing of the print job in accordance with the designated value (determination result of an inspector). For example, when it is determined that the reference image is normal and the inspection image is normal, the print job is restarted. Furthermore, when it is determined that the reference image is normal and the inspection image is abnormal, recovery printing is performed. Furthermore, when it is determined that the reference image is abnormal and the inspection image is normal, the print job is restarted, and the difference is not determined as abnormal even when detected at the same portion in the second or subsequent copy. Furthermore, when it is determined that the reference image is abnormal and the inspection image is abnormal, the print job is aborted.

Next, description will be given of the image inspection method of the present embodiment with reference to FIGS. 5 and 6. An inspection level setting screen 40 as illustrated in FIG. 5 is displayed on the operation panel 23 or the like, and the inspector sets an appropriate inspection level in advance depending on a required quality level of the printed matter. FIG. 5 is an example in which the inspection level can be set to three levels of “loose”, “normal”, and “strict”. Furthermore, since the required quality is different depending on the printing company even when any inspection level is set, it is enabled to further assign numerical values from 1 to 7 for each inspection level (stain detection level, sheet noise removal level, image edge periphery detection sensitivity, reference image stain tolerance level, or the like).

Here, the inspection level is divided into seven levels of 1 to 7, and the inspection level is changed in the inspection mode. FIG. 5 is an example of a case where the inspection level is set to “strict”, and in the print jobs to be performed after that, the inspection is executed at the level of “07” regarding the stain detection level, the sheet noise removal level, and the image edge periphery detection sensitivity. Furthermore, when “loose” is set, the stain detection level and the sheet noise removal level are inspected at the inspection level of “02”, and when “normal” is set, the stain detection level and the sheet noise removal level are inspected at the inspection level of “04”. Note that, here, when an inspection level is set, the print jobs to be executed after that are executed at the inspection level, but the inspection level may be set for each print job.

Then, as illustrated in FIG. 6, when the inspection level is set to “loose” or “normal” by the inspector, the document image is set as a reference image used for the image inspection (see the upper part of FIG. 6), and when the inspection level is set to “strict”, the image obtained by reading the sheet printed in the proof mode is set as a reference image used for the image inspection (see the lower part of FIG. 6). As described above, when high image quality is not required for the printed matter, the image inspection is performed with the document image as the reference image, whereby the visual confirmation work on the image read from the printed sheet can be omitted. Furthermore, when high image quality is required for the printed matter, the image inspection is performed with the image obtained by reading the sheet printed in the proof mode as the reference image, whereby the inspection accuracy can be improved.

Hereinafter, description will be given of an image inspection procedure using the image inspection system 10 of the present embodiment. The CPU constituting the controller 21 execute processing of the steps illustrated in the flowcharts of FIGS. 7 and 8 by deploying an image inspection program stored in the ROM or the storage 22 in the RAM and executing the image inspection program.

The inspection level setter 31 causes the operation panel 23 or the like to display the inspection level setting screen 40 as illustrated in FIG. 5, and the inspector operates the operation panel 23 to set the inspection level to any of “loose”, “normal”, or “strict” (S101). Next, the controller 21 executes a print job, and the document image acquisition unit 30 receives print job information including a document image (S102). Next, the controller 21 determines whether or not the inspection level is set to “strict” (S103). When the inspection level is set to other than “strict” (No in S103), the controller 21 determines whether or not the proof mode is designated in the print job (S106).

Note that, the proof mode (test printing) is a mode in which one copy is printed in advance before actual printing (printing in the inspection mode) is executed, and it is confirmed whether there is no mistake in the print job settings, a desired print result is obtained, and the like, and the proof mode in the image inspection system 10 is also a step of registering an image obtained by reading a printed sheet as a reference image in the image inspection system 10.

When the inspection level is set to “strict” (Yes in S103) or when the proof mode is designated in the print job (Yes in S106), the controller 21 executes the proof mode (S104), selects an image obtained by reading a sheet printed in the proof mode as a reference image, and registers the reference image in the image inspection system 10 (S105). On the other hand, when the inspection level is set to “loose” or “normal” (No in S103) and the proof mode is not designated in the print job (No in S106), the controller 21 selects the document image as a reference image, and registers the reference image in the image inspection system 10 (S107).

Next, the controller 21 executes the print job, and executes image inspection 1 by comparing the selected reference image with an inspection image obtained by reading a printing sheet (S108). FIG. 8 illustrates the details of this step. First, the document image acquisition unit 30 receives the document image from the image processor (controller) 26 or the like (S111). Next, the printer (image writer) 25 feeds a printing sheet from a sheet feeding tray (S112) and prints the document image on the printing sheet (S113).

Next, the image reader 27 reads the printing sheet on which the document image is printed (S114), and the first image inspector 32 or the second image inspector 33 performs image inspection (S115). Specifically, when the image obtained by reading the sheet printed in the proof mode is selected as the reference image in S105 of FIG. 7, the first image inspector 32 performs difference inspection by comparing the image (the reference image) obtained by reading the sheet printed in the proof mode with an image (inspection image) obtained by reading a sheet printed in the inspection mode. Furthermore, when the document image is selected as the reference image in S107 of FIG. 7, the second image inspector 33 performs the difference inspection by comparing the document image (reference image) with the image (inspection image) obtained by reading the sheet printed in the inspection mode.

As a result of the difference inspection, when there is a difference between the reference image and the inspection image (that is, an image defect is detected) (Yes in S116), the controller 21 gives a recovery printing instruction to the image processor (controller) 26 (S117). Then, the controller 21 determines whether or not printing of all pages is completed (S118), and when the printing of all pages is not completed (No in S118), the processing returns to S111, and the next document image is received.

As described above, when high image quality is not required for the printed matter, if the inspection level is set relatively low (for example, “loose” or “normal”), the document image is selected as the reference image, so that it is possible to omit a step of generating the reference image in advance in the proof mode and work of visually confirming whether or not there is a problem in the reference image. Furthermore, when the high image quality is required for the printed matter, if the inspection level is set relatively high (for example, “strict”), the proof mode is executed and the image obtained by reading the sheet printed in the proof mode is selected as the reference image, so that highly accurate image inspection can be performed.

### Second Embodiment

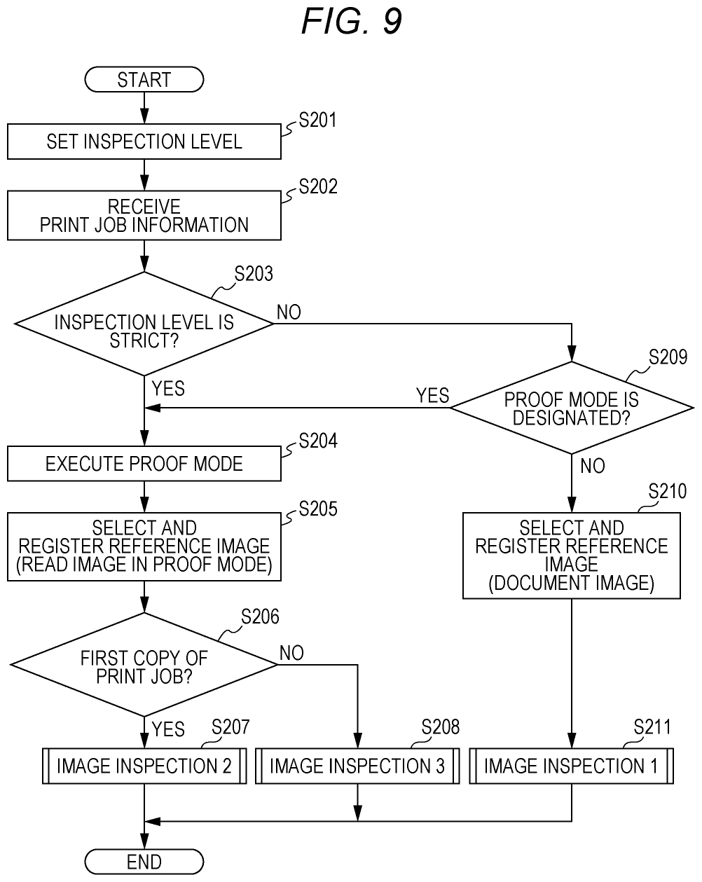

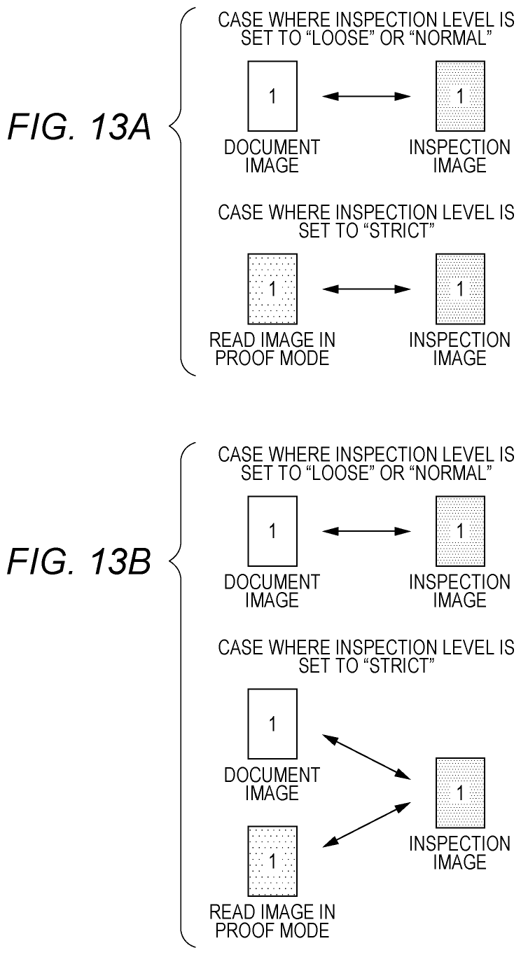

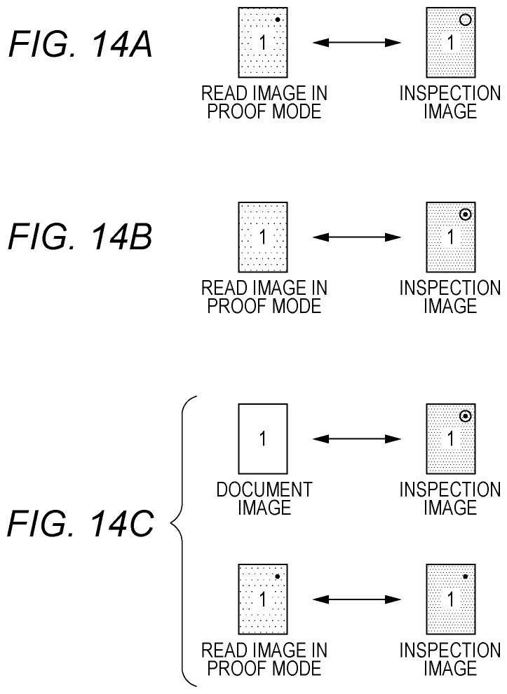

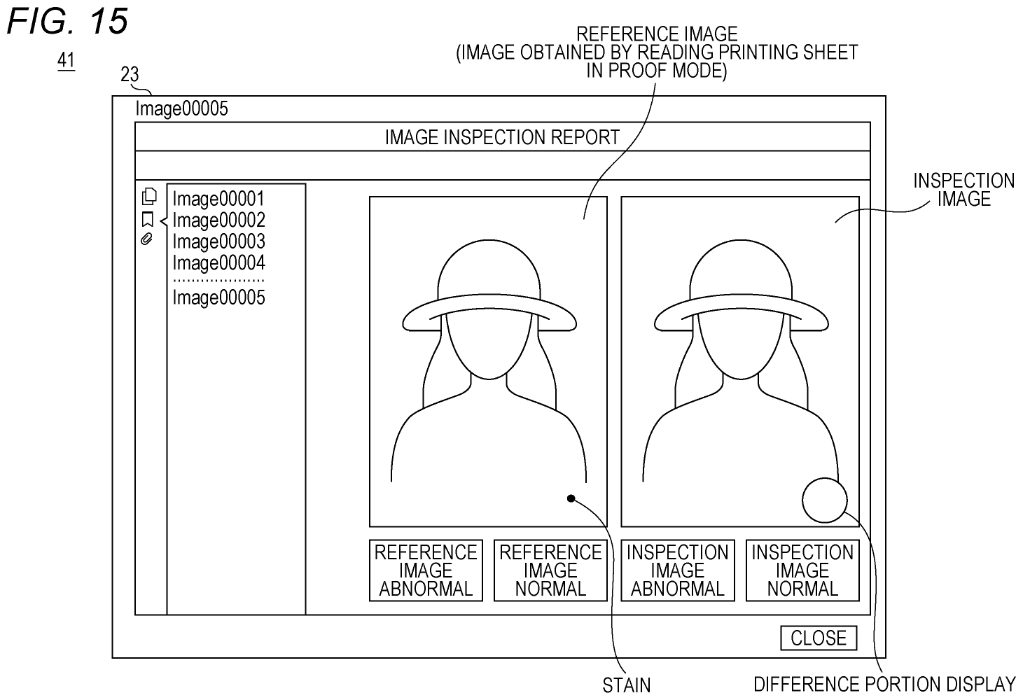

Next, description will be given of an image inspection apparatus, an image inspection method, and an image inspection program according to a second embodiment of the present invention with reference to FIGS. 9 to 15. FIGS. 9 to 12 are flowcharts illustrating operation of the image inspection system of the present embodiment, and FIGS. 13A, 13B, and 14A to 14C are schematic diagrams explaining image inspection 2 of the present embodiment. Furthermore, FIG. 15 is an example of a screen (inspection result screen) displayed on the image inspection system of the present embodiment.

In the first embodiment described above, a case has been described where the reference image (the image obtained by reading the sheet printed in the proof mode or the document image) and the inspection image (the image obtained by reading the sheet printed in the inspection mode) are compared with each other; however, when a stain on the reference image is overlooked during a visual inspection in a case where the image obtained by reading the sheet printed in the proof mode is used as the reference image, an image abnormality cannot be detected even when there is the same stain in the inspection image. Thus, in the present embodiment, when the image obtained by reading the sheet printed in the proof mode is used as the reference image, a possibility is determined that there is an abnormality in the reference image by comparing the reference image, the document image, and the inspection image with each other.

In that case, the configuration of the image inspection system 10 is similar to that of the first embodiment described above; however, the first image inspector 32 determines a possibility that there is an abnormality in the reference image obtained by reading the sheet printed in the proof mode, in printing of the first copy after the proof mode, on the basis of a first difference between the reference image obtained by reading the sheet printed in the proof mode and an inspection image obtained by reading a sheet printed in the first copy, and a second difference between the document image and the inspection image obtained by reading the sheet printed in the first copy. Then, when it is determined that there is a possibility of abnormality in the reference image obtained by reading the sheet printed in the proof mode, the inspection image is not determined as abnormal even when the first difference is detected between the reference image and an inspection image obtained by reading a sheet printed after the second or subsequent copy.

Furthermore, when the first image inspector 32 determines that there is the possibility of abnormality in the reference image obtained by reading the sheet printed in the proof mode, the inspection result display 34 displays the reference image obtained by reading the sheet printed in the proof mode (or the reference image and the inspection image) on the inspection result screen. Furthermore, the inspection result display 34 clearly indicates a difference portion between the reference image and the inspection image on the inspection result screen.

Furthermore, when the first image inspector 32 determines that there is the possibility of abnormality in the reference image obtained by reading the sheet printed in the proof mode, the image normality or abnormality designator 35 accepts designation of whether the reference image obtained by reading the sheet printed in the proof mode and the inspection image are normal or abnormal.

Furthermore, when the first image inspector 32 determines that there is the possibility of abnormality in the reference image obtained by reading the sheet printed in the proof mode, the controller 21 causes the image writer 25 to suspend processing of a print job.

Hereinafter, description will be given of an image inspection procedure using the image inspection system 10 of the present embodiment. The CPU constituting the controller 21 execute processing of the steps illustrated in the flowcharts of FIGS. 9 to 12 by deploying an image inspection program stored in the ROM or the storage 22 in the RAM and executing the image inspection program.

The inspection level setter 31 causes the operation panel 23 or the like to display the inspection level setting screen 40 as illustrated in FIG. 5, and the inspector operates the operation panel 23 to set the inspection level to any of “loose”, “normal”, or “strict” (S201). Next, the controller 21 executes a print job, and the document image acquisition unit 30 receives print job information including a document image (S202). Next, the controller 21 determines whether or not the inspection level is set to “strict” (S203). When the inspection level is set to other than “strict” (No in S203), the controller 21 determines whether or not the proof mode is designated in the print job (S209).

When the inspection level is set to “strict” (Yes in S203) or when the proof mode is designated in the print job (Yes in S209), the controller 21 executes the proof mode (S204), selects an image obtained by reading a sheet printed in the proof mode as a reference image, and registers the reference image in the image inspection system 10 (S205).

Next, the controller 21 determines whether or not it is the first copy of the print job (S206), and when it is the first copy of the print job (Yes in S206), the first image inspector 32 executes the image inspection 2 by using the document image, the reference image obtained by reading the sheet printed in the proof mode, and an inspection image (S207). The image inspection 2 will be described later. On the other hand, in the case of the second or subsequent copy of the print job (No in S206), the first image inspector 32 executes image inspection 3 by using the document image, the reference image obtained by reading the sheet printed in the proof mode by a reading apparatus, and an inspection image (S208). The image inspection 3 will also be described later.

On the other hand, when the inspection level is set to “loose” or “normal” (No in S203) and the proof mode is not designated in the print job (No in S209), the controller 21 selects the document image as a reference image, and registers the reference image in the image inspection system 10 (S210). Next, the controller 21 executes the print job, and executes the image inspection 1 by comparing the selected reference image (document image) with an inspection image obtained by reading a printed sheet (S211). The image inspection 1 is the same as that of the first embodiment, and thus description thereof is omitted.

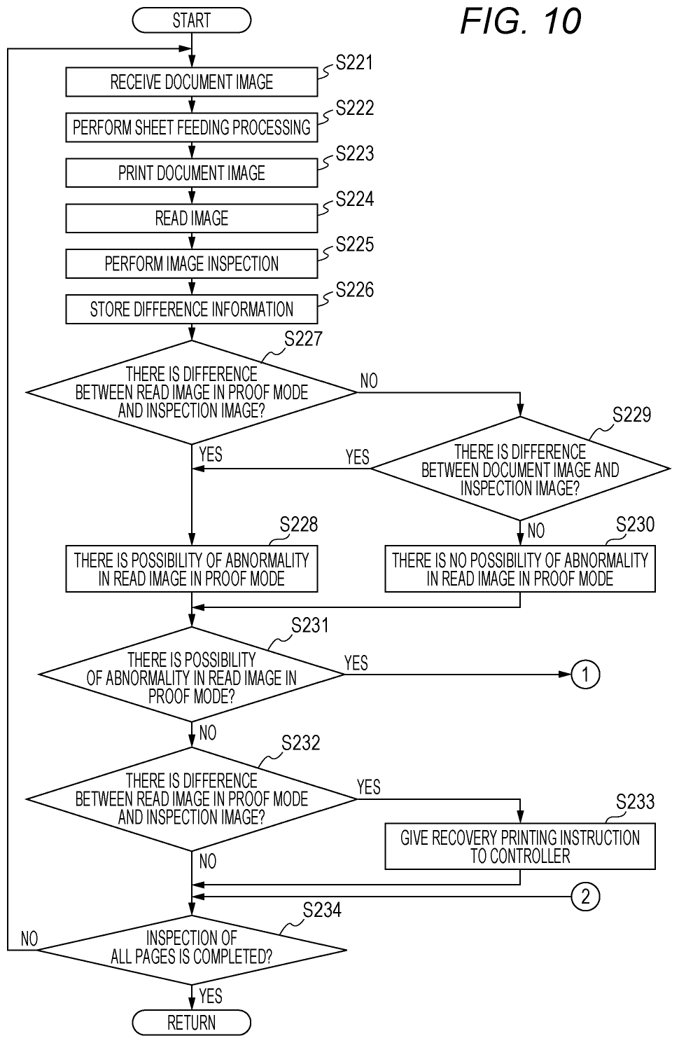

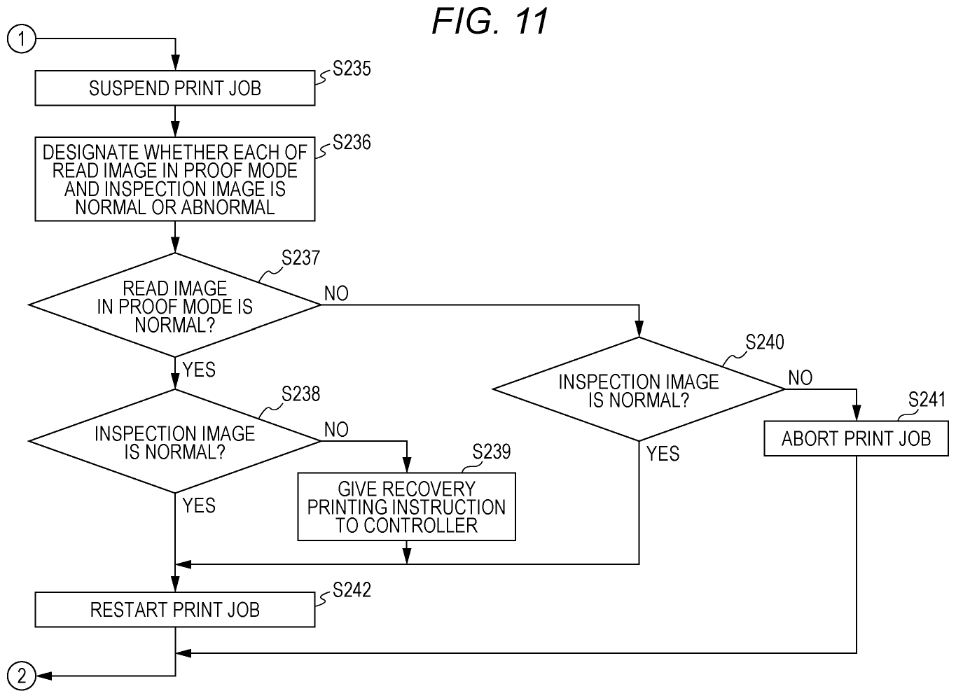

Next, the image inspection 2 will be described with reference to FIGS. 10 and 11. Note that FIGS. 10 and 11 are divided for convenience of drawing figures, and illustrate a series of operations.

First, the document image acquisition unit 30 receives the document image from the image processor (controller) 26 or the like (S221). Next, the printer (image writer) 25 feeds a printing sheet from a sheet feeding tray (S222) and prints the document image on the printing sheet (S223). Next, the image reader 27 reads the printing sheet on which the document image is printed (S224), and the first image inspector 32 performs difference inspection by comparing the reference image obtained by reading the sheet printed in the proof mode, the document image, and the inspection image (S225), and stores difference information (S226). The difference information includes (A) difference information (position, difference) between the reference image obtained by reading the sheet printed in the proof mode and the inspection image of the first copy, and (B) difference information (position, difference) between the reference image obtained by reading the sheet printed in the proof mode and the document image.

Next, the first image inspector 32 determines whether or not there is a difference between the reference image obtained by reading the sheet printed in the proof mode and the inspection image, on the basis of the difference inspection (S227), and when there is no difference (No in S227), determines whether or not there is a difference between the document image and the inspection image (in this case, the same as the reference image obtained by reading the sheet printed in the proof mode) (S229). When there is a difference between the reference image obtained by reading the sheet printed in the proof mode and the inspection image (Yes in S227), or when there is no difference between the reference image obtained by reading the sheet printed in the proof mode and the inspection image (No in S227) but there is a difference between the document image and the inspection image (Yes in S229), the first image inspector 32 determines that there is a possibility of abnormality in the reference image obtained by reading the sheet printed in the proof mode (S228). On the other hand, when there is no difference between the reference image obtained by reading the sheet printed in the proof mode and the inspection image (No in S227) and there is no difference between the document image and the inspection image (No in S229), the first image inspector 32 determines that there is no possibility of abnormality in the reference image obtained by reading the sheet printed in the proof mode (S230).

Next, when there is no possibility of abnormality in the reference image obtained by reading the sheet printed in the proof mode (No in S231) and there is a difference between the reference image obtained by reading the sheet printed in the proof mode and the inspection image (S232 Yes), the controller 21 gives a recovery printing instruction to the image processor (controller) 26 (S233). Then, the controller 21 determines whether or not printing of all pages is completed (S234), and when the printing of all pages is not completed (No in S234), the processing returns to S221, and the next document image is received.

On the other hand, when there is a possibility of abnormality in the reference image obtained by reading the sheet printed in the proof mode (Yes in S231), the processing proceeds to FIG. 11, and the controller 21 suspends the print job (S235). Then, the inspection result display 34 displays the reference image obtained by reading the sheet printed in the proof mode and the inspection image on the operation panel 23 or the like, and the image normality or abnormality designator 35 allows the inspector to designate whether each of the reference image obtained by reading the sheet printed in the proof mode and the inspection image is normal or abnormal (S236). At that time, as necessary, when it is determined from the determination result of S227 that there is a difference between the reference image obtained by reading the sheet printed in the proof mode and the inspection image, a difference portion between the reference image and the inspection image is clearly indicated. Furthermore, when it is determined that there is no difference between the reference image obtained by reading the sheet printed in the proof mode and the inspection image from the determination result of S227, and there is a difference between the document image and the inspection image from the determination result of S229, a difference portion between the document image and the inspection image is clearly indicated on the reference image side.

When the inspector determines the reference image obtained by reading the sheet printed in the proof mode as normal (Yes in S237), it is determined whether or not the inspector determines the inspection image as normal (S238), and when the inspection image is determined as normal (Yes in S238), the controller 21 restarts the print job (S242) and the processing proceeds to S234 in FIG. 10. Furthermore, when the inspection image is not determined as normal, the controller 21 instructs the image processor (controller) 26 to perform recovery printing (S239), and then restarts the print job (S242), and the processing proceeds to S234 in FIG. 10. Furthermore, when the inspector does not determine the reference image obtained by reading the sheet printed in the proof mode as normal (No in S237), it is determined whether or not the inspector determines the inspection image as normal (S240), and when the inspection image is determined as normal (Yes in S240), the controller 21 restarts the job (S242) and the processing proceeds to S234 in FIG. 10, and when the inspection image is not determined as normal (No in S240), the controller 21 aborts the print job (S241) and the processing proceeds to S234 in FIG. 10.

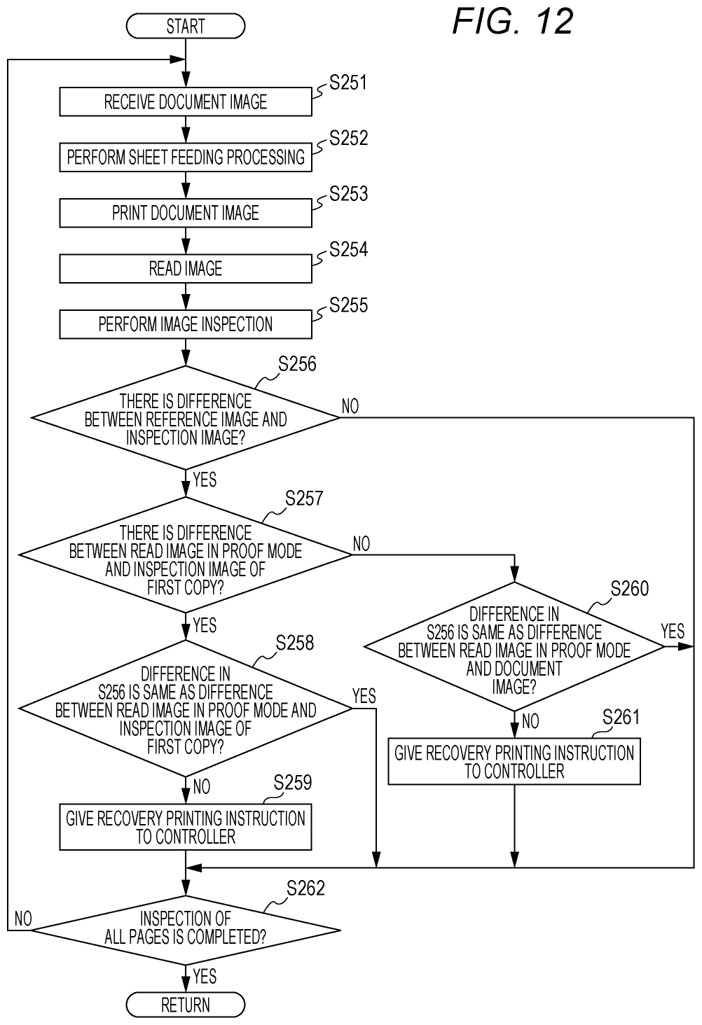

Next, the image inspection 3 will be described with reference to FIG. 12.

First, the document image acquisition unit 30 receives the document image from the image processor (controller) 26 or the like (S251). Next, the printer (image writer) 25 feeds a printing sheet from a sheet feeding tray (S252) and prints the document image on the printing sheet (S253). Next, the first image inspector 32 performs difference inspection by comparing the reference image selected in S205 with an inspection image obtained by reading the sheet printed on the second or subsequent copy in the inspection mode (S255).

Then, the first image inspector 32 determines whether or not there is a difference between the reference image and the inspection image (S256). When it is determined that there is a difference (Yes in S256), the first image inspector 32 determines whether there is a difference between the reference image obtained by reading the sheet printed in the proof mode and the inspection image of the first copy (S257).

When there is a difference between the reference image obtained by reading the sheet printed in the proof mode and the inspection image of the first copy (Yes in S257), the first image inspector 32 determines whether or not the difference in S256 (the difference between the reference image and the inspection image of the second or subsequent copy) is the same as (A) the difference (position, difference) between the reference image obtained by reading the sheet printed in the proof mode and the inspection image of the first copy (S258). When the difference between the reference image and the inspection image of the second or subsequent copy is the same as (A) (Yes in S258), the controller 21 determines whether or not printing of all pages is completed (S262), and when the printing of all pages is not completed, the processing returns to S251, and the next document image is received. When the difference between the reference image and the inspection image of the second or subsequent copy is different from (A) (No in S258), the controller 21 gives a recovery printing instruction to the image processor (controller) 26 (S259). Then, the controller 21 determines whether or not the printing of all pages is completed (S262), and when the printing of all pages is not completed, the processing returns to S251, and the next document image is received.

When it is determined that there is no difference between the reference image obtained by reading the sheet printed in the proof mode and the inspection image of the first copy (No in S257), the first image inspector 32 determines whether or not the difference in S256 (the difference between the reference image and the inspection image of the second or subsequent copy) is the same as (B) the difference (position, difference) between the reference image obtained by reading the sheet printed in the proof mode and the document image (S260). When the difference between the reference image and the document image of the second or subsequent copy is the same as (B) (Yes in S260), the controller 21 determines whether or not the printing of all pages is completed (S262), and when the printing of all pages is not completed, the processing returns to S251, and the next document image is received. When the difference between the reference image and the document image of the second or subsequent copy is different from (B) (No in S260), the controller 21 gives a recovery printing instruction to the image processor (controller) 26 (S261). Then, the controller 21 determines whether or not the printing of all pages is completed (S262), and when the printing of all pages is not completed, the processing returns to S251, and the next document image is received.

As described above, both the image obtained by reading the sheet printed in the proof mode and the document image are used as the reference image, whereby it is enabled to inspect a possibility that there is an abnormality in the image obtained by reading the sheet printed in the proof mode, and it is possible to prevent an image inspection with an image having an abnormality as a reference.

Next, the image inspection 2 will be described with reference to FIGS. 13A, 13B, and 14A to 14C. As illustrated in FIG. 13A, in the first embodiment, when the inspection level is set to “loose” or “normal”, the image inspection is performed by selecting the document image as the reference image, and when the inspection level is set to “strict”, the image inspection is performed by selecting the image obtained by reading the sheet printed in the proof mode as the reference image. On the other hand, as illustrated in FIG. 13B, in the second embodiment, when the inspection level is set to “strict”, both the document image and the image obtained by reading the sheet printed in the proof mode are used as the reference image. Note that, when the inspection level is set to “loose” or “normal”, it is the same as in the first embodiment, and thus description thereof is omitted.

Here, when the image obtained by reading the sheet printed in the proof mode is used as the reference image, the inspector needs to visually confirm whether or not there is an abnormality in the printed matter in the proof mode, but it is easy to overlook a tiny stain, and an abnormality at a position overlapping with the printed content. Thus, in the second embodiment, when the inspection level is set to “strict”, the image inspection is performed by using both the document image and the image obtained by reading the sheet printed in the proof mode as the reference image, and the possibility is inspected that there is an abnormality in the image obtained by reading the sheet printed in the proof mode. Then, when the possibility is detected that there is an abnormality in the image obtained by reading the sheet printed in the proof mode, the image is displayed and the inspector is notified, to allow the inspector to perform determination of normality or abnormality, which can assist the visual confirmation of the sheet printed in the proof mode.

Specifically, when there is a difference at the same portion between the image obtained by reading the sheet printed in the proof mode and the inspection image (that is, when there is a stain in one of the image obtained by reading the sheet printed in the proof mode or the inspection image) as illustrated in FIGS. 14A and 14B, and when there is a difference at the same portion between the document image and the inspection image, and there is no difference at the same portion between the image obtained by reading the sheet printed in the proof mode and the inspection image as illustrated in FIG. 14C, it is determined that there is a possibility of abnormality in the image obtained by reading the sheet printed in the proof mode.

Then, when it is determined that there is a possibility of abnormality in the image obtained by reading the sheet printed in the proof mode, the image obtained by reading the sheet printed in the proof mode and the inspection image are displayed on the operation panel 23 or the like, and when there is a difference at the same portion between the image obtained by reading the sheet printed in the proof mode and the inspection image, the difference is clearly indicated in the inspection image. Furthermore, when there is a difference at the same portion between the document image and the inspection image, and there is no difference at the same portion between the image obtained by reading the sheet printed in the proof mode and the inspection image, the difference between the document image and the inspection image is clearly indicated in the inspection image. After that, the inspector is allowed to determine whether the image obtained by reading the sheet printed in the proof mode and the inspection image are normal or abnormal.

As a result, even when there is an abnormality in the image obtained by reading the sheet printed in the proof mode, it is possible to prevent erroneous detection that the inspection image is determined as abnormal. Furthermore, the inspector is allowed to determine whether there is no abnormality in the image obtained by reading the sheet printed in the proof mode, and the determination result is stored in the image inspection system 10, so that it is not necessary to execute the proof mode again and create the reference image again even when there is an abnormality in the image obtained by reading the sheet printed in the proof mode. Furthermore, the possibility is determined of an abnormality in the image obtained by reading the sheet printed in the proof mode, which can assist the visual confirmation of the sheet printed in the proof mode.

Next, description will be given of the image inspection result using the image inspection system 10 of the present embodiment with reference to FIG. 15. FIG. 15 is an example of a case where it is determined that there is a possibility of abnormality in the image obtained by reading the sheet printed in the proof mode, in the inspection mode of the fifth page of the first copy of the print job. When it is determined that there is a possibility of abnormality in the image obtained by reading the sheet printed in the proof mode, the image (reference image) obtained by reading the sheet printed in the proof mode and the inspection image are displayed side by side on the operation panel 23 or the like.

When it is determined from the inspection result of S225 of FIG. 10 that there is a difference portion between the image obtained by reading the sheet printed in the proof mode and the inspection image, the difference portion between the image obtained by reading the sheet printed in the proof mode and the inspection image is clearly indicated on the inspection image side. Furthermore, when it is determined from the determination result of S225 of FIG. 10 that there is no difference portion between the image obtained by reading the sheet printed in the proof mode and the inspection image, and there is a difference between the document image and the inspection image, the difference portion between the document image and the inspection image is clearly indicated on the inspection image side.

When determining that there is no problem in the image obtained by reading the sheet printed in the proof mode, the inspector selects a reference image normal button, and when determining that there is a problem in the image obtained by reading the sheet printed in the proof mode, the inspector selects a reference image abnormal button. Similarly, when it is determined that there is no problem in the inspection image, the inspection image normal button is selected, and when it is determined that there is a problem in the inspection image, the inspection image abnormal button is selected.

Then, when the image obtained by reading the sheet printed in the proof mode is determined as normal and the inspection image is determined as abnormal, recovery printing is performed. Furthermore, when the image obtained by reading the sheet printed in the proof mode is determined as abnormal and the inspection image is determined as normal, the suspended print job is restarted. Furthermore, when the image obtained by reading the sheet printed in the proof mode is determined as normal and the inspection image is also determined as normal, the suspended print job is restarted. Furthermore, when the image obtained by reading the sheet printed in the proof mode is determined as abnormal and the inspection image is also determined as abnormal, the reference image needs to be recreated in the proof mode, and thus the print job is aborted. Then, on the basis of the determination of normality or abnormality selected by the inspector, (A) difference information (position, difference) between the reference image obtained by reading the sheet printed in the proof mode and the inspection image, and (B) difference information (position, difference) between the reference image obtained by reading the sheet printed in the proof mode and the document image are stored, and the second or subsequent copy of the print job is inspected on the basis of the difference information.

As a result, in the inspection mode, it is possible to prevent erroneous detection due to the fact that there is an abnormality in the image itself obtained by reading the sheet printed in the proof mode. Furthermore, since the inspection of the second or subsequent copy is executed on the basis of the difference information, it is enabled to continue the image inspection without executing proof mode again even when there is a problem in the image obtained by reading the sheet printed in the proof mode.

Note that, the present invention is not limited to the above embodiments, and its configuration and control can be appropriately changed without departing from the spirit of the present invention.

For example, in the above embodiments, the image inspection system 10 has been described in which the image forming apparatus 20a and the image inspection apparatus 20b are integrally formed together; however, the image inspection method of the present invention can be similarly applied to a case where the image inspection apparatus 20b is operated alone. In that case, it is sufficient that the image forming apparatus 20a and the image inspection apparatus 20b are communicably connected to each other, and the image inspection apparatus 20b is provided with the document image acquisition unit 30, the inspection level setter 31, the first image inspector 32, the second image inspector 33, the inspection result display 34, the image normality or abnormality designator 35, the operation panel 23, and the like.

The present invention can be used for an image inspection apparatus that inspects an image obtained by reading a document image printed on a sheet, an image inspection method using the image inspection apparatus, an image inspection program that operates in the image inspection apparatus, and a recording medium that records the image inspection program.

Although embodiments of the present invention have been described and illustrated in detail, the disclosed embodiments are made for purposes of illustration and example only and not limitation. The scope of the present invention should be interpreted by terms of the appended claims

What is claimed is:

1. An image inspection apparatus that performs inspection on an image obtained by reading a sheet on which a document image is printed, the image inspection apparatus comprising:
a hardware processor that controls the inspection;
an inspection level setter that sets an inspection level of the inspection;
a first image inspector that performs the inspection with an image obtained by reading a sheet printed in a proof mode as a reference image; and
a second image inspector that performs the inspection with the document image as a reference image, wherein
the hardware processor causes the second image inspector to execute the inspection when the inspection level is set relatively low, and causes the first image inspector to execute the inspection when the inspection level is set relatively high.

2. The image inspection apparatus according to claim 1, wherein
the first image inspector determines a possibility that there is an abnormality in the image obtained by reading the sheet printed in the proof mode, in printing of a first copy of an inspection mode after the proof mode, on the basis of a first difference between the image obtained by reading the sheet printed in the proof mode and an image obtained by reading a sheet printed in the first copy, and a second difference between the document image and the image obtained by reading the sheet printed in the first copy.

3. The image inspection apparatus according to claim 2, wherein
when determining that there is a possibility of abnormality in the image obtained by reading the sheet printed in the proof mode, the first image inspector does not determine an image obtained by reading a sheet printed in a second or subsequent copy as abnormal even when detecting the first difference between the image obtained by reading the sheet printed in the proof mode and the image obtained by reading the sheet printed in the second or subsequent copy.

4. The image inspection apparatus according to claim 2, further comprising
an inspection result display that displays at least the image obtained by reading the sheet printed in the proof mode when the first image inspector determines that there is a possibility of abnormality in the image obtained by reading the sheet printed in the proof mode.

5. The image inspection apparatus according to claim 4, wherein
the inspection result display displays a difference portion between the image obtained by reading the sheet printed in the proof mode and an image obtained by reading a sheet printed in the inspection mode.

6. The image inspection apparatus according to claim 4, further comprising
an image normality or abnormality designator that accepts normality or abnormality designation for the image obtained by reading the sheet printed in the proof mode and an image obtained by reading a sheet printed in the inspection mode.

7. The image inspection apparatus according to claim 2, further comprising
an image writer that prints the document image on a sheet on the basis of a print job, wherein
the hardware processor causes the image writer to suspend processing of the print job when the first image inspector determines that there is a possibility of abnormality in the image obtained by reading the sheet printed in the proof mode.

8. An image inspection method in an image inspection apparatus that performs inspection on an image obtained by reading a sheet on which a document image is printed, the image inspection method comprising:
executing inspection level setting processing of setting an inspection level of the inspection;
executing first image inspection processing of performing the inspection with an image obtained by reading a sheet printed in a proof mode as a reference image;
executing second image inspection processing of performing the inspection with the document image as a reference image; and
executing the second inspection processing when the inspection levels is set relatively low, and executing the first inspection processing when the inspection level is set relatively high.

9. The image inspection method according to claim 8, wherein
the first image inspection processing determines a possibility that there is an abnormality in the image obtained by reading the sheet printed in the proof mode, in printing of a first copy of an inspection mode after the proof mode, on the basis of a first difference between the image obtained by reading the sheet printed in the proof mode and an image obtained by reading a sheet printed in the first copy, and a second difference between the document image and the image obtained by reading the sheet printed in the first copy.

10. The image inspection method according to claim 9, wherein
when determining that there is a possibility of abnormality in the image obtained by reading the sheet printed in the proof mode, the first image inspection processing does not determine an image obtained by reading a sheet printed in a second or subsequent copy as abnormal even when detecting the first difference between the image obtained by reading the sheet printed in the proof mode and the image obtained by reading the sheet printed in the second or subsequent copy.

11. The image inspection method according to claim 9, further comprising
executing inspection result display processing of displaying at least the image obtained by reading the sheet printed in the proof mode when the first image inspection processing determines that there is a possibility of abnormality in the image obtained by reading the sheet printed in the proof mode.

12. The image inspection method according to claim 11, wherein
the inspection result display processing displays a difference portion between the image obtained by reading the sheet printed in the proof mode and an image obtained by reading a sheet printed in the inspection mode.

13. The image inspection method according to claim 11, further comprising
executing image normality or abnormality designation processing of accepting normality or abnormality designation for the image obtained by reading the sheet printed in the proof mode and an image obtained by reading a sheet printed in the inspection mode.

14. The image inspection method according to claim 9, wherein
the image inspection apparatus includes an image writer that prints the document image on a sheet on the basis of a print job, and
the first image inspection processing causes the image writer to suspend processing of the print job when determining that there is a possibility of abnormality in the image obtained by reading the sheet printed in the proof mode.

15. A non-transitory recording medium storing a computer readable image inspection program that operates in an image inspection apparatus that performs inspection on an image obtained by reading a sheet on which a document image is printed, the image inspection program causing
a hardware processor of the image inspection apparatus to execute:
inspection level setting processing of setting an inspection level of the inspection;
first image inspection processing of performing the inspection with an image obtained by reading a sheet printed in a proof mode as a reference image;
second image inspection processing of performing the inspection with the document image as a reference image; and
the second inspection processing when the inspection levels is set relatively low, and the first inspection processing when the inspection level is set relatively high.

16. The non-transitory recording medium storing a computer readable image inspection program according to claim 15, wherein
the first image inspection processing determines a possibility that there is an abnormality in the image obtained by reading the sheet printed in the proof mode, in printing of a first copy of an inspection mode after the proof mode, on the basis of a first difference between the image obtained by reading the sheet printed in the proof mode and an image obtained by reading a sheet printed in the first copy, and a second difference between the document image and the image obtained by reading the sheet printed in the first copy.

17. The non-transitory recording medium storing a computer readable image inspection program according to claim 16, wherein
when determining that there is a possibility of abnormality in the image obtained by reading the sheet printed in the proof mode, the first image inspection processing does not determine an image obtained by reading a sheet printed in a second or subsequent copy as abnormal even when detecting the first difference between the image obtained by reading the sheet printed in the proof mode and the image obtained by reading the sheet printed in the second or subsequent copy.

18. The non-transitory recording medium storing a computer readable image inspection program according to claim 16, wherein
the inspection program further causes the hardware processor to execute
inspection result display processing of displaying at least the image obtained by reading the sheet printed in the proof mode when the first image inspection processing determines that there is a possibility of abnormality in the image obtained by reading the sheet printed in the proof mode.

19. The non-transitory recording medium storing a computer readable image inspection program according to claim 18, wherein
the inspection result display processing displays a difference portion between the image obtained by reading the sheet printed in the proof mode and an image obtained by reading a sheet printed in the inspection mode.

20. The non-transitory recording medium storing a computer readable image inspection program according to claim 18, wherein
the inspection program further causes the hardware processor to execute
image normality or abnormality designation processing of accepting normality or abnormality designation for the image obtained by reading the sheet printed in the proof mode and an image obtained by reading a sheet printed in the inspection mode.

21. The non-transitory recording medium storing a computer readable image inspection program according to claim 16, wherein
the image inspection apparatus includes an image writer that prints the document image on a sheet on the basis of a print job, and
the first image inspection processing causes the image writer to suspend processing of the print job when determining that there is a possibility of abnormality in the image obtained by reading the sheet printed in the proof mode.
